(19) United States
(12) Patent Application Publication
(10) Pub. No.: US 2014/0136314 A1
(43) Pub. Date: May 15, 2014

(54) Interactive Technology for Conversational Marketing in Mobile Devices

(71) Applicant: GOLD POST TECHNOLOGIES, INC., Las Vegas, NV (US)

(72) Inventors: Quyen Kiet, Anaheim (US); Barry Goldstein, Las Vegas (US); Uttam Shah, Torrance (US)

(73) Assignee: GOLD POST TECHNOLOGIES, INC., Las Vegas, NV (US)

(21) Appl. No.: 13/743,556

(22) Filed: Jan. 17, 2013

Related U.S. Application Data
(60) Provisional application No. 61/724,525, filed on Nov. 9, 2012.

(51) Int. Cl. G06Q 30/02

(52) U.S. Cl. CPC G06Q 30/0242
USPC 705/14.41

(57) ABSTRACT

An apparatus and method that give users the opportunity to identify which ad content is interesting and report information about these interested users to advertisers. The apparatus delivers digital visual advertising on the user's mobile device as part of an App's function. When the advertising message window appears, the user can dismiss the advertising message by touching the ad with a finger and swiping it left or right, depending on whether the user finds the ad content interesting or not. If interested, the user swipes the ad message to the right, and if not interested, swiping to the left; both action dismisses the ad and the user can resume activity prior to the ad message. The apparatus records the user's interest when the ad is swiped to the right and communicates this interest to the advertiser for future retargeted ads of similar content to the user.

### RELATED APPLICATION

This application is a non-provisional application of and claims benefit to the U.S. Provisional Application for Interface Design System For Increasing Mobile Advertising Effectiveness (U.S. Provisional Pat. App. 61/724,525), filed on Nov. 9, 2012, the specification of which is included in its entirety by this reference.

### BACKGROUND OF THE INVENTION

1. Field of the Invention

The present invention relates to computer system, more specifically, relates to advertising display and interaction on a mobile computing system.

2. Description of Related Arts

Advertising on mobile computing system (mobile devices) is transmitted in various ways and generally follows the paradigms set by traditional web based browser advertising methods such as banner ads and “popup” windows traditionally seen on a desktop computer. However, in applying these desktop advertising methods to mobile devices, the effectiveness is significantly reduced because the mobile device screen is significantly smaller (smartphones are typically between 4 and 5 inches in width), which means a banner ad on a smartphone would have significantly less content and is much harder to read. Therefore, banner ads which saw some conversions on a desktop browser see very little conversion on the mobile format. Also, on the smaller mobile screens, banner ads and popup windows are more difficult to close and dismiss due to the small size of the “x” icon used to dismiss these banner and popup ad windows.

Facebook™ attempted to categorize user preferences of content and advertising by creating the “like” button in the form of a thumbs up icon to identify content the user “likes”, but Facebook™ failed to transfer this user preference into an actionable advertising design paradigm for small screen devices like smartphones, tablet computers and other mobile devices.

Currently, advertising message windows or “popups” that appear on a mobile device whether via mobile browser or native application are dismissed by an icon showing an “[x]” on one of the four corners of the popup window; this [x] represents the universally accepted icon to mean “dismiss and close this window” on Microsoft Windows™ operating systems, or a red dot on Apple's desktop operating system. The [x] (or red dot depending on operating system) has been used to represent the “dismiss” or “close” window function on most programs running on Microsoft Windows, as well as on all internet browser windows. Similarly, use of this [x] symbol continues unchanged for popup windows that appear on mobile devices.

Shortcomings of the [x] icon. With just the [x] on a popup window that does nothing more than close the advertising window, the advertiser does not know whether the user was interested in the content—the user is not given the option to let the advertiser know the user is interested in the advertised content despite his dismissal of the window. Banner and popup ads that employ the [x] dismissal function only informs the advertiser of the user interest ONLY IF the user clicks on the advertising and is taken to the linked content—which poses a burden to the user if the user does not wish to open another window to read about the advertising subject matter at that very moment. Currently, there is no way for the user to dismiss the advertising popup window while also letting the advertiser know that although the user dismissed the advertising, the user was interested in that content—just not at that moment.

There are applications that use the “swipe” or “slide” navigation to initiate a software action in response to a finger touching an image on-screen and moving said image. But there is no technology that exploits the direction of such swiping in the context of advertising content interaction as this invention has.

Therefore, there is a need for a system that enables an advertiser to detect a user's interests even if the user dismisses an ad that shows up on a popup window on his mobile device and it is to this system that the present invention is primarily directed.

### SUMMARY OF THE INVENTION

The present invention provides a system and a method for detecting a user's interest on an ad that shows up on a popup window on his mobile device even if the user dismisses such popup window. The present invention also provides an apparatus and method that improves advertising effectiveness on mobile devices by facilitating “conversational marketing” with consumers. “Conversational Marketing” is when advertisers communicate with consumers and consumers are given an opportunity to respond to said communication. The present invention relies on a specific method of user interactivity together with a unique manner of delivering advertising on a mobile device screen that enables users to respond conveniently and quickly to ad content.

The present invention is a method for delivering advertisements onto a mobile device with a positive side and a negative side, the positive side being opposite to the negative side. The method comprises displaying, on to a display screen of the mobile device, an advertising window containing an advertisement over a currently active window on the display screen, receiving an input, through the advertising window, from a user, disengaging the advertising window according to the input, if the advertising window is disengaged to the positive side of the display screen, recording the input as a positive response, and if the advertising window is disengaged to the negative side of the display screen, recording the input as a negative or neutral response.

The present system and methods are therefore advantageous as they detect a user's interest on an ad even if the user dismisses such ad. Other advantages and features of the present invention will become apparent after review of the hereinafter set forth Brief Description of the Drawings, Detailed Description of the Invention, and the Claims.

### BRIEF DESCRIPTION OF THE DRAWINGS

Features and advantages of embodiments of the invention will become apparent as the following detailed description proceeds, and upon reference to the drawings, where like numerals depict like elements, and in which:

FIG. 1 depicts a mobile device with an advertising screen;

FIG. 2 depicts the advertising screen moving from left to right side;

FIG. 3 depicts the advertising screen moving from right to left side;

FIG. 4 depicts flow of advertising information;

FIG. 5 is architecture of an apparatus according to the invention; and

FIG. 6 is a flowchart for determining user interest for an advertising display.

### DETAIL DESCRIPTION OF THE INVENTION

In an overview, the present invention discloses an apparatus and method that improve advertising effectiveness for mobile devices by enabling user conversation for engagement and identifying user interest for retargeted advertising. The present invention relies on a specific method of user interactivity together with a unique manner of delivering advertising on a mobile device screen that encourages user interactivity with advertised content.

Traditionally, internet advertising networks use retargeted ads by employing cookies to track a consumer's product interest by analyzing a consumer's web browsing history (duration and frequency of visits to certain websites) in order to predict which advertised content would match the consumer's demonstrated web browsing interest. However, this paradigm is of limited utility on mobile devices because most mobile device users spend time on dedicated mobile applications (or “apps”) such as games (ie/Angry Birds) or entertainment (ie/YouTube) rather than web browsing. In response to this challenge, the present invention provides the platform for advertisers to bring conversational marketing and retargeted advertising for the mobile device space.

Definitions.

A. “Mobile Device” describes touch interactive hand held portable internet devices such as smartphones, computer tablets, “phablet” devices (combining the functions of a smartphone with the larger screen), or any other hand held mobile device with a touch interactive screen and internet connection.

B. “User” is used herein to describe a natural person interacting with the mobile device.

C. “App” is any software application running on a mobile device that the user is interacting with.

D. “Swipe” or “Slide” navigation is a form of interaction between the User and mobile device whereby the User touches an image on the screen and moves the finger to move the image in order to trigger a response from the image.

E. “Retargeted Advertising” describes a method of advertising that identifies and delivers advertising about a specific content “A” to consumers previously identified as showing interest in content “A” because those consumers have previously acted in a manner that demonstrated interest in content “A”, such as visiting a website that talks about content “A”, or a website that sells products similar to content “A”.

F. “Hot leads” are users who are most likely to respond positively to Retargeted Advertising because they have demonstrated a recent interest in the content that is being retargeted to the user. For example, a user browses through an online catalog for winter black boots. This user is can now be considered a “hot lead” for any advertiser selling black boots or boots or winter wear.

G. “Cognitive Congruence” (“CC”) (also referred to Cognitively Congruent Interaction or “CC Interaction). CC interaction means that the user's interaction with a mobile device is in harmony and congruent with the user's current state of mind. CC recognizes that this user state of mind includes two key elements:
a. User Expectation. Users have existing expectations of how transactions occur in the real world from experience, so they would expect that virtual objects in a mobile device should also operate under the same conventions.
b. User Convenience. User convenience can be affected by forcing the

Users to delay or prolong their intended activities due to disruptions that interrupt their intended activity.

CC Design Benefits Elaborated. By focusing on the cognitive dimension available to the touch navigation paradigm unique to mobile devices like smartphones and tablets, the present invention fills the vacuum not addressed by current mobile advertising methods and technologies. Unlike the keyboard-mouse navigation paradigm where desktop computer users have this layer of indirect devices separating them from their on-screen control, the touch navigation interface for mobile devices allows the user to affect directly the software on-screen to navigate its functions. This direct touch opens up an additional dimension of design opportunities not addressed by previous methods and technologies focused on the mouse-keyboard navigation paradigm.

H. Example. An interaction that follows the CC design principle is as follows: on the mobile device screen, an image of a basketball appears at the top of the screen and falls to the bottom of the screen, and bounces on the bottom like a ball should. This movement of the basketball makes sense to the User—it is cognitively congruent or in harmony with the User's expectation of the real world where a basketball falls from top to bottom, and bounces upon hitting the ground, and if the User's finger touches the screen in the path of the falling basketball, it would bounce off the area of the screen touched by the finger, as it continues its downward path. It would be confusing to the User to witness a basketball rising up from the bottom of the screen to the top because this is in direct conflict with the User's understanding of how a basketball interacts with gravity.

I. Value of CC Design. In the above example, because the User has seamlessly interacted with a virtual world without an intervening control device (like mouse or keyboard), the User feels a unity of experience that is in congruence with the User's expectations. Thus, CC improves User interactivity because the User's virtual engagement (control of mobile device screen content) is seamless with the User's presence in the real world. This sense of seamless continuity, when applied to mobile advertising would invite User engagement with advertising content on mobile devices that incorporate CC into its design.

Following CC design principles, the present invention improves user interactivity with advertising content on mobile devices by including this cognitive dimension to facilitate the emotional connection with advertising content delivered on a mobile device. This is a new and distinct dimension not previously explored by the mouse and keyboard paradigm of the desktop computer era, but unique to touch screen interactivity in mobile devices. Mobile device interaction relies on that direct interaction between the user's fingers and the mobile device screen, which creates additional dimension of sensory engagement that is addressed by the present invention to help advertisers connect with and appeal to users.

The present mobile advertising technology offers better conversion rates for advertisers because it improves on the following areas of mobile device advertising: (1) enables User engagement with advertising content, (2) identifies User's interest or disinterest in the advertising content, (3) identifies which Users are “hot leads”, and (4) gives advertisers a cognitive dimension for designing more “conversational” advertising interactivity.

The most important consequence is the present invention identifies “hot leads”, which are users who have recently shown affirmative interest in an advertised product and thus are more likely to commit to buying the advertised product if the advertiser re-targets that User with additional advertising of said product.

Until this invention, no mobile advertising technology has combined the functionalities of the [x] dismissal action with preference identification with CC interactivity that in one action can simultaneously (1) conveniently “dismiss and close” an advertising window, (2) immediately provide the user's preference (positive or negative) for retargeted advertising, and (3) appeal to the user's cognitive sensibilities via cognitively concordant touch interaction. With the present invention, advertisers can more effectively use retargeted advertising to reach users who have previously shown an interest in specific advertising content.

The present invention teaches a unique method for delivering advertising onto a mobile device screen that allows the advertiser to “hot leads” for retargeted advertising by delivering advertising content in a way that allows the user to identify themselves as “hot leads.” When advertising is delivered via the present invention, the user is able to (1) quickly read and recognize the advertising content on a window superimposed over whatever app was in the foreground, (2) expediently dismiss the content, (3) concurrently communicate the user's opinion of the content (in one of two ways, depending which direction is swiped), (4) all while remaining cognitively congruent throughout this process.

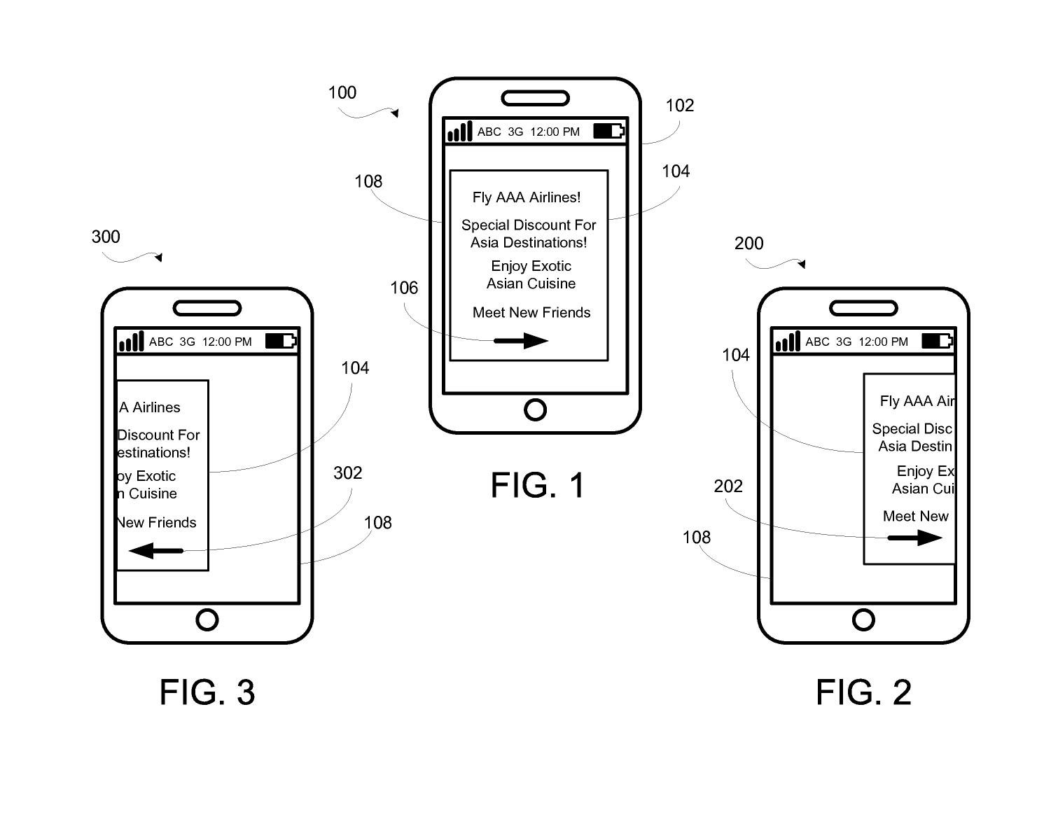

FIG. 1 is an illustration 100 of a mobile device 102 with an ad display 104 “sliding” through an active window on the display screen 108 of the mobile device 102. The arrow 106 indicates the direction that the ad display flows; it flows from left to right. As the ad display flows through the display screen 108, the user can swipe the ad display left or right to move the ad display out of the display screen 108. When the user swipes the ad display either to the right or to the left, a message will appear behind the ad confirming the user's negative or positive opinion, and then quickly disappear as if dragged away by the ad. FIG. 2 is an illustration 200 of the ad display 104 flowing to the right hand side of the display screen 108 as indicated by the arrow 202. FIG. 3 is an illustration 300 of the ad display 104 flowing to the left hand side of the display screen 108 as indicated by the arrow 302.

The present invention is cognitively congruent and more effective than existing methods as follows: (1) the user response to advertising delivered in this way is consistent with the user's expectation of real world interaction. Just like in the real world, when one rejects a gift or purchase, one returns it to the source, on a mobile device when a User receives an advertising window from left to right, the user simply moves the advertising window back to the left to express “rejection” of this object and if the user “accepts” the advertising as interesting, then the User helps the advertising message along on its trajectory from left all the way to the right, and the User is able to move this advertisement as easily as moving a hockey puck left or right with a finger swipe; (2) the user's state of mind is not disrupted because the user is able to quickly comprehend the advertising content and expediently discard the advertising message with minimal interruption to the user, while at the same time express an interest or lack of interest in the ad simply by directing the ad message back where it came from to the left or helping it along its path to the right.

Once the dismissal of the advertising message is complete, and the user has concurrently expressed an opinion of the advertised content (sliding the advertisement to the left is the user's expression of a negative sentiment, while sliding the advertisement to the right is a positive expression), the present invention records this user's sentiment on its server and communicates this preference to the advertiser for future retargeted ad delivery to this user.

Because the present invention is an advertisement delivery system installed as part of any App interested in benefiting from advertising revenue, it has access to the user's registration information from the App. Based on that information (Facebook, Twitter, email), advertisers can retargeted ads to the user who show a positive opinion of the ad. So advertisers can now retarget the user on other platforms (social networks like Facebook, social messaging like Twitter, group buying networks like Groupon, direct messaging like email, etc.) about content that the user had expressed positive sentiments towards. Retargeted Advertising is now available to monitor mobile device users who spend more time on apps than on browsing.

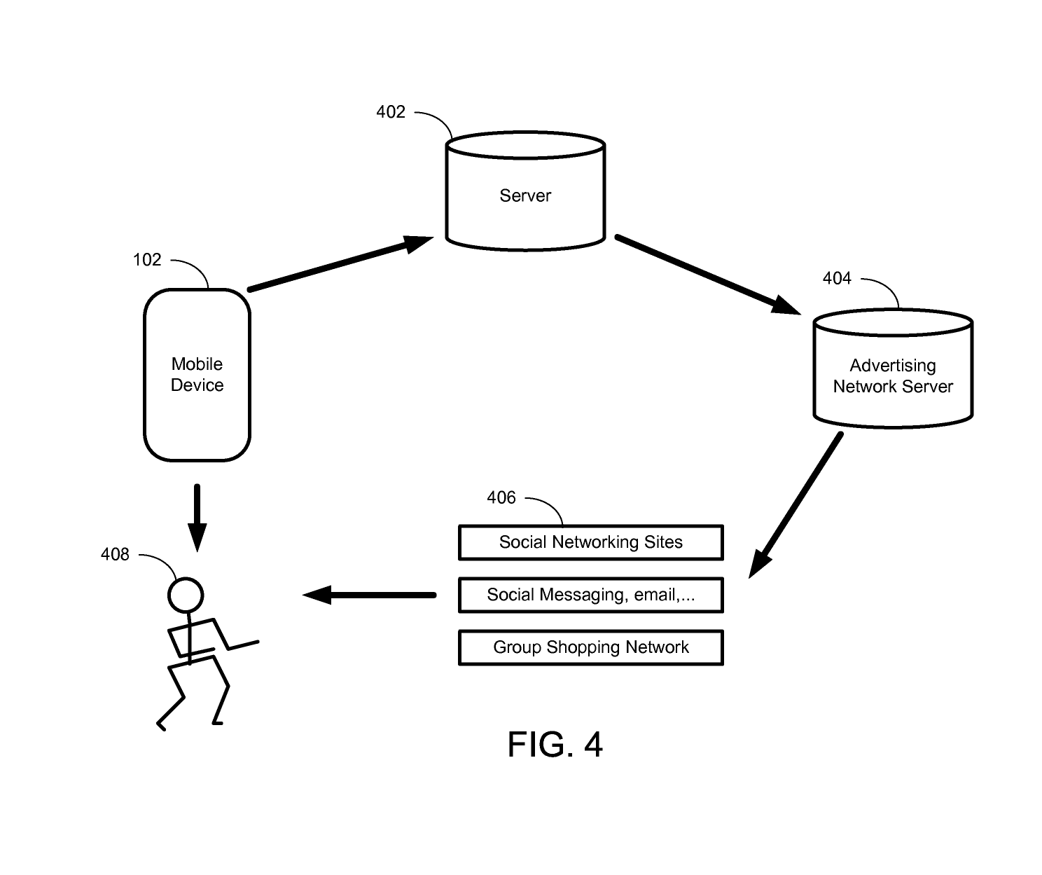

FIG. 4 illustrates a use scenario for the present invention. The mobile device 102 will display an ad and as the ad is dismissed by the swiping action, the indication about the user's interest is sent to a server 402. Assuming that the indication is positive regarding the user's interest, the information about the user is sent to an advertising network server 404. The information on this advertising network server 404 is used by advertisers to target the user 408 on other social platforms 406 with ultimate objective of resulting sales.

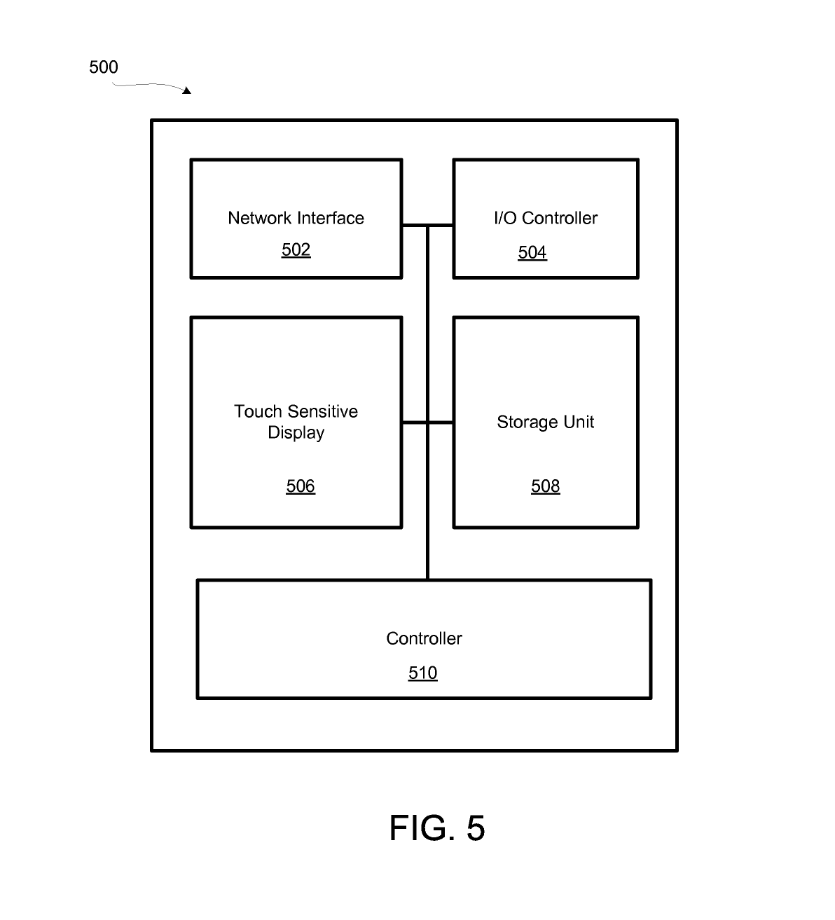

FIG. 5 is an architecture 500 of a device according to the invention. The device comprises a network interface unit 502 for sending and receiving information to server 402, a touch sensitive display 506 for displaying applications and ads to the user, an I/O controller 504 for controlling display on the touch sensitive display 506, a storage unit 508 for storing user information and applications, and a controller 510 for controlling the operation of the device. This device displays an animated advertising window, on the touch sensitive display screen 506, (containing the advertised content) that “slides” from left to right across an active window displayed on the mobile device screen as it appears; the “left to right” movement of the advertising window is important because people in the U.S. (and other Western societies) read text from left to right, and thus, seeing information sliding from left to right is concordant with how information is expected to appear. As the advertising window slides rightward on the mobile device screen, it stops once it is centered on the screen. Once the user has had the opportunity to comprehend the advertised content, the user will see indicators on the advertisement explaining that the user with a fingertip can dismiss this advertising in one of two ways: (1) touch the advertisement window and slide it (or “swipe” it) back to the left which represents a “negative” response as if the user was returning the advertisement back to its source, or (2) swipe the window to the right which represents a “positive” response as if user was helping the advertisement continue on its course toward the user. This action concurrently dismisses the advertising window as it slides either left or right and disappears.

Most importantly, touching the advertising window does not take the user to another link or window away from the user's pending activity on the mobile device, and just as quickly as an [x] icon, dismisses the window, but unlike the [x] icon, there is no risk that the user misses the [x] and unexpectedly opens a browser window.

After the advertising window is dismissed with a positive response, the user's action is detected by the touch sensitive display 506 and captured by the I/O controller 504. Because of the positive response, the controller 510 may collect user information from the storage unit 508 and send the user information to the server 402 through the network interface 502.

Optionally, the user may set up his/hers own preference on the positive response. Instead of sliding a display window from left to right to indicate a positive response, the user can set up his own preference, for example sliding the advertising window from right to left or sliding the advertising window up (or down) as an indication of positive response. The user preference is stored in the storage unit 508 and used by the advertising window when sliding into the touch sensitive display screen 506. This option is useful when the mobile device is used in countries with different languages or when the advertising window contains special information or animation images.

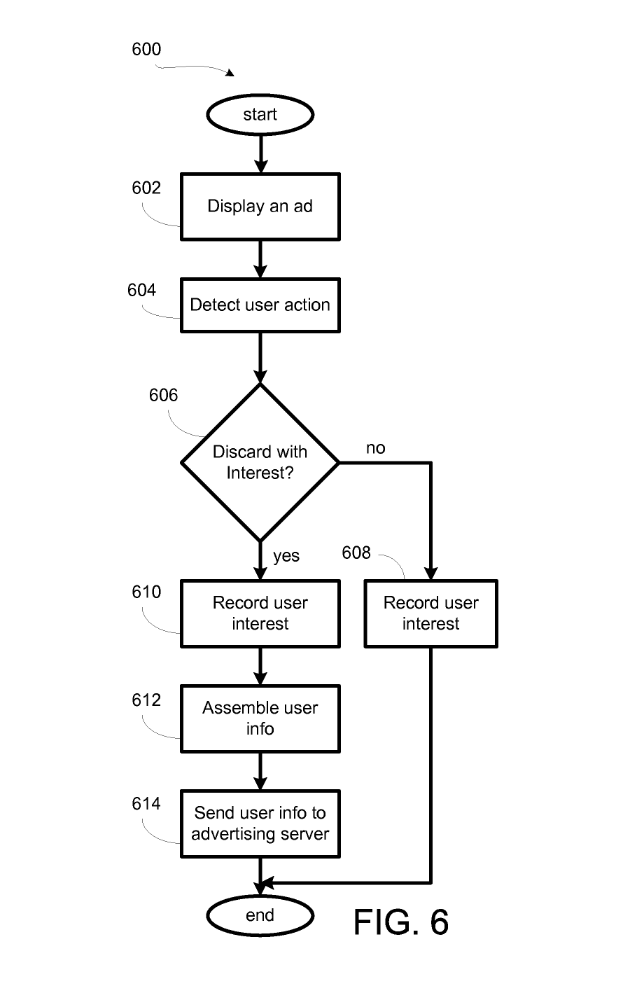

FIG. 6 is a flowchart 600 for display and dismissing an advertising display window. An advertisement is displayed on an active window on the touch sensitive display screen 506, step 602, by sliding from right to left (or another direction depending on the user preference). As the user dismisses the ad by sliding it across the touch sensitive display screen 506, the user's action is detected, step 604, and the controller 510 determines whether the user discarded the ad window with interest, step 606. If the ad window is discarded or disengaged without interest, i.e., the ad window is slid out of the touch sensitive display screen 506 in an direction that indicates no user interest, the controller 510 will record that the user has no interest in the product or service displayed on the ad window, step 608. If the ad window is discarded or disengaged with an indication of user interest, i.e., the ad window is slid out of the touch sensitive display screen 506 in an direction that indicates the user having interest, the controller 510 will record that the user has interest in the product or service displayed on the ad window, step 610. After the user interest is detected and recorded, the controller 510 will retrieve user data, such as the mobile phone number or the user ID if the ad window is displayed when the user is logged onto a particular website or playing a particular game, from the storage unit 508 and assemble user information, step 612. The collected user information is sent to an external advertising server 402, step 614.

The display of an advertising window can be tailored by the user. The default display maybe set by the application that launches the advertising window. However, the user may set up his personal preferences, such as advertising windows slide in to the touch sensitive display screen from right to left, or from left to right, sliding an advertising window to the left indicates user interest or no user interest. User can also select up/down as a preference as well. The user preferences affect how the advertising windows are displayed to the user.

1. A method for delivering advertisements onto a mobile device with a positive side and a negative side, the positive side being opposite to the negative side, comprising the steps of:
displaying, on to a display screen of the mobile device, an advertising window containing an advertisement over a currently active window on the display screen;
receiving an input, through the advertising window, from a user;
disengaging the advertising window according to the input;
if the advertising window is disengaged to the positive side of the display screen, recording the input as a positive response; and
if the advertising window is disengaged to the negative side of the display screen, recording the input as a negative or neutral response.

2. The method of claim 1 further comprising the step of receiving the advertisement from an ad server.

3. The method of claim 1 further comprising the step of defining the positive side and the negative side.

4. The method of claim 1 further comprising the steps of:
retrieving user data from a storage unit;
assembling user information; and
sending the user information to an advertising server.

5. A mobile device comprising:
a network interface for communicating with an external server;
a storage unit for storing user data;
a touch sensitive display screen for displaying an advertising window;
an I/O controller for receiving a user input for discarding the advertising window on the touch sensitive display screen; and
a controller for interpreting the user input as positive or negative,
wherein
positive being associated with user interest and negative being associated with non-user interest,
the controller further being capable of retrieving the user data, assembling user information, and sending the assembled user information to the external server via the network interface.

6. The mobile device of claim 5, wherein the positive and the negative being defined by the user.

7. The mobile device of claim 5, wherein the advertising window slides across an active window on the touch sensitive display screen.
